(19) United States
(12) Patent Application Publication
(10) Pub. No.: US 2016/0252119 A1
(43) Pub. Date: Sep. 1, 2016

(54) SERRATED SHAFT-ENGAGING SURFACE FOR SHRINK DISC

(71) Applicant: FOREMOST INDUSTRIES LP, Calgary (CA)

(72) Inventors: Cornel BACIU, Calgary (CA); Douglas C. SECORD, Calgary (CA)

(73) Assignee: FOREMOST INDUSTRIES LP, Calgary (CA)

(21) Appl. No.: 14/633,930

(22) Filed: Feb. 27, 2015

(51) Int. Cl. F16B 7/04

(52) U.S. Cl. CPC F16B 7/0426

(57) ABSTRACT

A shrink disc, compression ring for a shrink disc, insert for interposing between a shrink disc and a shaft, and associated methods are provided. In each case, a serrated inner surface of the compression ring or insert is provided which is configured to grippingly engage the shaft. Protrusions of the serrated surface may mark or intrude into the shaft. The compression ring or insert may be provided in multiple arcuate parts for circumferential arrangement about the shaft. Various protrusion configurations, including symmetric and sawtooth, are provided. The shrink disc is generally operable to apply radially inward pressure to the shaft for example using a wedge effect.

### FIELD OF THE INVENTION

The present invention pertains in general to the field of shrink discs for mounting to an element such as a cylindrical shaft, and in particular to a serrated shaft-engaging surface for use with or integrated into a shrink disc.

### BACKGROUND

Shrink discs are well-known devices in the art that may be employed for radially engaging a radially symmetric element, such as a cylindrical shaft, in furtherance of various purposes. For example, Application Publication No. WO 2013/049885 discloses a shrink disc type coupler assembly for transmitting torque between two concentric rotating shafts. As another example, shrink discs may be used to apply inward radial compression to a hollow shaft into which another component is inserted, thereby causing the hollow shaft to grip the component.

A first style of shrink disc includes a compression ring with a cylindrical bore and a conical outer surface, and a pressure ring with a conical inner surface which is fitted overtop of the compression ring. A second style of shrink disc includes a compression ring with a cylindrical bore and a bi-conical outer surface which tapers outward in both directions from its axial center, and a two-part pressure ring, each part defining a corresponding portion of a mating bi-conical inner surface which is fitted overtop of the compression ring. In either case, as the pressure ring is moved axially, it engages the compression ring and causes a radial compression due to a wedge effect induced by engagement of the two conical surfaces. The axial movement can be induced for example by operation of a set of screws, bolts, or other means which function to move the pressure ring axially overtop of the compression ring. In the first style, the screws may engage bores formed within a flange of the compression ring and within the pressure ring. In the second style, the screws may engage bores formed within the two parts of the pressure ring. Other means of applying radial pressure may be used which potentially do not rely on the wedge effect. For example, a heated pressure ring and/or compression ring may be applied to the shaft, with radial pressure applied due to thermal contraction of the pressure ring/compression ring material upon cooling thereof.

However, in various instances, if a sufficient amount of torque is applied to a shrink disc, it may undesirably rotationally slip relative to the shaft. Therefore there is a need for a method and apparatus for facilitating engagement between a shrink disc apparatus and a shaft that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of the present invention is to provide a serrated shaft-engaging surface for use with or integrated into a shrink disc and an associated method. In accordance with an aspect of the present invention, there is provided an apparatus for interposing between a shaft and a portion of a shrink disc assembly, the shrink disc assembly configured to receive the shaft within an aperture thereof and to selectably apply a radially inward pressure to the shaft, the apparatus comprising a serrated inner surface configured to grippingly engage the shaft.

In accordance with another aspect of the present invention, there is provided a shrink disc assembly comprising: a ring mechanism defining an internal aperture configured to receive a shaft therein, the ring mechanism operable to selectably apply a radially inward pressure to the shaft, the internal aperture comprising an inner surface having one or more protrusions configured to grippingly engage the shaft upon application of said radially inward pressure.

In accordance with another aspect of the present invention, there is provided a method of coupling a shrink disc assembly to a shaft, the method comprising: locating the shaft within an internal aperture defined by the shrink disc assembly, the internal aperture comprising an inner surface having one or more protrusions; and operating the ring mechanism to apply a radially inward pressure to the shaft via the inner surface, the radially inward pressure causing the one or more protrusions to grippingly engage the shaft.

In accordance with another aspect of the present invention, there is provided a method of coupling a shrink disc assembly to a shaft, the method comprising: providing an insert apparatus defining an internal aperture, the internal aperture comprising an inner surface having one or more protrusions; locating the shaft within the internal aperture of the insert apparatus; locating the insert apparatus within a further internal aperture defined by the shrink disc assembly; and operating the ring mechanism to apply a radially inward pressure to the insert apparatus and to the shaft via the insert apparatus, the radially inward pressure causing the one or more protrusions of the insert apparatus to grippingly engage the shaft.

### BRIEF DESCRIPTION OF THE FIGURES

FIGS. 1A to 1C illustrate cross-sectional partial views of a serrated shaft-engaging surface and a corresponding shaft, in accordance with an embodiment of the present invention.

FIG. 2 illustrates an insert apparatus provided in accordance with an embodiment of the present invention.

FIG. 3 illustrates an insert apparatus provided in accordance with another embodiment of the present invention.

FIG. 4 illustrates a compression ring portion of a shrink disc, in accordance with embodiments of the present invention.

FIGS. 5A to 5C respectively illustrate plan, cross-sectional and perspective views of a shrink disc comprising the compression ring portion of FIG. 4 as well as a pressure ring portion disposed radially outward of the compression ring, in accordance with embodiments of the present invention.

FIG. 6 illustrates a single-conical style of shrink disc assembly provided in accordance with another embodiment of the present invention.

FIG. 7 illustrates a thermal expansion style compression ring for disposal on a shaft, in accordance with embodiments of the present invention.

FIGS. 8A to 8D illustrate configurations of protrusions of a serrated surface, in accordance with various embodiments of the present invention.

FIGS. 9A to 9C illustrate a pair of shafts coupled together using a shrink disc assembly, in accordance with embodiments of the present invention.

### DETAILED DESCRIPTION

### Definitions

As used herein, the term “axial” refers to a substantially straight-line direction which is parallel to a relevant axis of symmetry, such as the axis of a cylindrical shaft to which a shrink disc is to be fitted, or the axis of a central bore of the shrink disc.

As used herein, the term “radial” refers to a substantially straight-line direction which extends perpendicularly from or to the axial direction.

As used herein, the term “circumferential” refers to a substantially circularly curved direction which follows the circumference of a circle of appropriate radius and centered on a relevant axis of symmetry, such as the axis of a cylindrical shaft to which a shrink disc is to be fitted, or the axis of a central bore of the shrink disc.

As used herein, the term “serrated” refers to a surface, such as a cylindrical surface, having one or more protrusions extending from the surface. A protrusion may extend perpendicularly from the surface or at an angle. Different protrusions may be shaped and oriented similarly or differently. The protrusions may be sparsely placed or may be arranged in a regular pattern over the surface, such as in a two-dimensional array. A protrusion may terminate substantially at a point, such as in a spike, or at a ridge, or the like.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

In accordance with an embodiment of the present invention, there is provided an apparatus comprising a serrated shaft-engaging surface for use with or integrated into a shrink disc. The serrated shaft-engaging surface is disposed on one or more members which generally define an aperture, such as a cylindrical aperture having two open ends. The aperture is sized and shaped for receiving a shaft of appropriate shape and diameter, and various embodiments of the invention may be configured for receiving various shapes and diameters of shaft. The shaft is typically cylindrical in shape, although it is contemplated that other shapes, such as conical shafts, may be accommodated.

The apparatus is configured to apply a radially inward pressure, via the shaft-engaging surface, which is generally adjustable within a predetermined range. In some embodiments, adjustment of the radially inward pressure may be associated with an adjustable diameter of the aperture. For example, the aperture diameter may be adjustable between a larger diameter and a smaller diameter. The larger diameter is associated with reduced radially inward pressure and is such that the shaft is movable within the aperture for insertion or removal. The smaller diameter is associated with increased radially inward pressure and is such that the serrated shaft-engaging surface grippingly engages the shaft, thereby inhibiting relative axial and/or rotational movement of the shaft with respect to the shaft-engaging surface and associated apparatus. As the shaft-engaging surface is serrated and hence comprises teeth or similar structures, the aperture diameter as mentioned above may correspond to the diameter as measured from the tips of the teeth.

Further, when the shaft is engaged within the aperture, the shaft may interfere with the serrated aperture surface and hence substantially inhibit reduction in the aperture diameter. As such, operation of the apparatus which would otherwise tend to reduce the aperture diameter may instead apply a radially inward pressure to the shaft, which may potentially increase in magnitude. In some embodiments, the radially inward pressure may cause the protrusions of the serrated surface to “bite” or intrude into the surface of the shaft, thus marking the surface of the shaft, and the aperture diameter may correspondingly reduce. Such biting action may correspond to the gripping engagement of the shaft. In various embodiments, the amount of intrusion of protrusions into the shaft may be significantly less than the total length of the protrusion. That is, the intrusion may correspond to a relatively shallow marking on the surface of the shaft rather than a deep intrusion into the shaft. This may aid in preserving structural integrity of the shaft as well as reducing the required range of diametric adjustability of the shrink disc.

In some embodiments, the protrusions on the serrated surface function to localize the radially inward pressure to a set of points or sub-regions which initially engage the shaft over less than an entirety of the shaft surface area. For example, the protrusions may correspond to an array of sharpened spikes or ridges. This localization of pressure may facilitate the intrusion of the protrusions into the shaft surface. Once the intrusion is established, the tortuous profile of the interface between the protrusions and the marked shaft surface may function to inhibit relative motion of the apparatus and the shaft, such as axial or rotational motion.

In some embodiments, the nature of the motion inhibition may depend on the shapes and orientations of the protrusions used. For example, if a protrusion is asymmetric, having at least one steeper side, that protrusion may operate to brace more effectively against forces which approach the protrusion from opposite the steeper side. In some embodiments, a plurality of protrusion shapes and orientations may be used in combination.

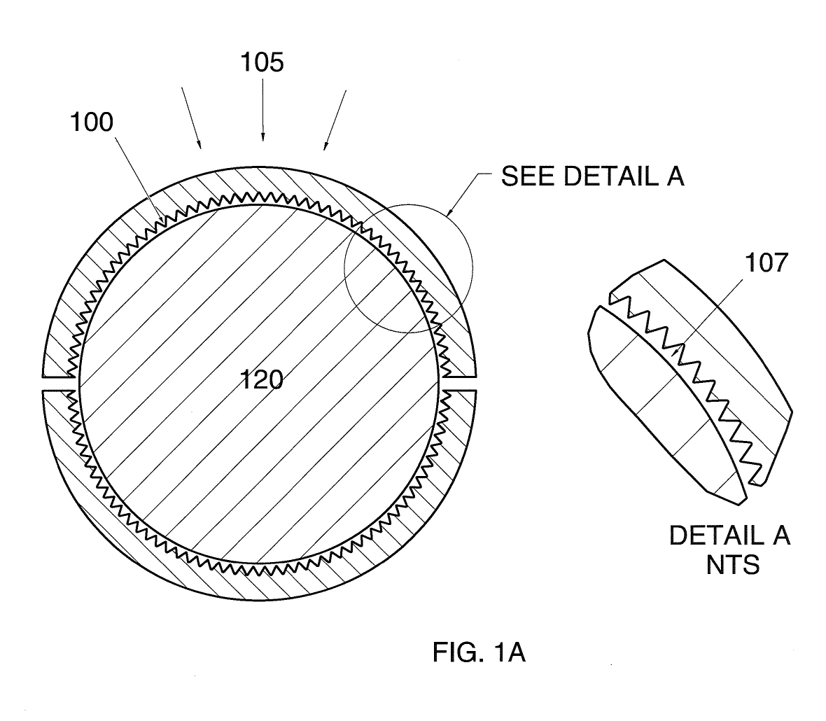

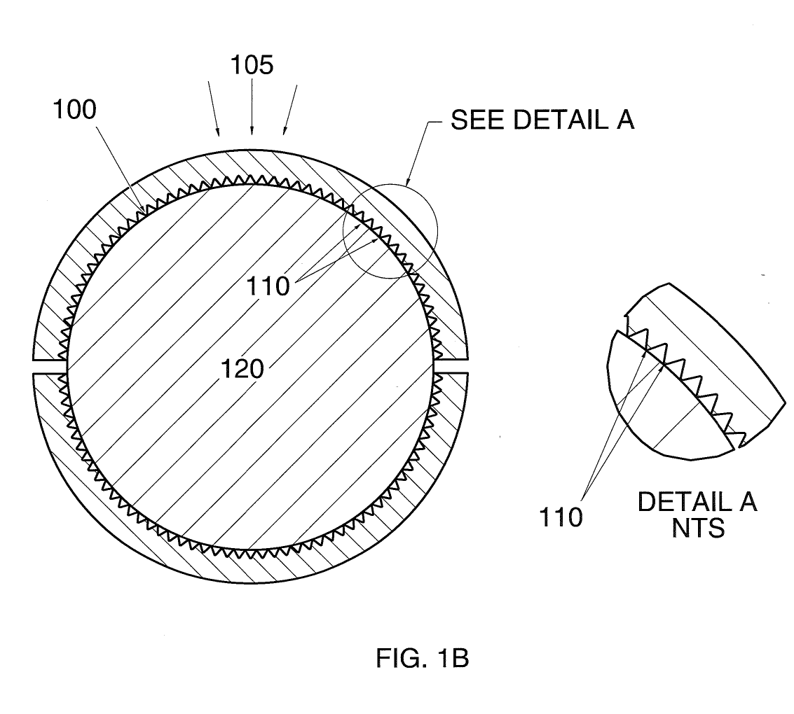

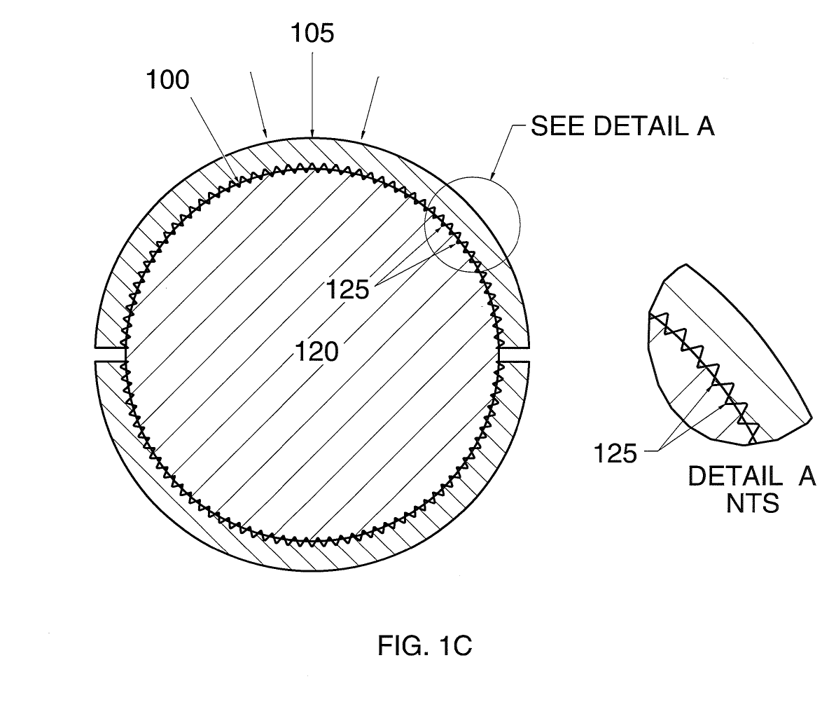

FIGS. 1A to 1C illustrate cross-sectional partial views of the apparatus of the present invention with a serrated shaft-engaging surface 100 and a corresponding shaft 120, in accordance with an embodiment of the present invention. In the configuration depicted in FIG. 1A, the shaft 120 is movable within the aperture defined by the shaft-engaging surface 100. A gap 107 may be present between the shaft 120 and shaft-engaging surface 100 in this configuration. In FIG. 1B, the aperture is reduced in size by an increase in the radially inward pressure 105 until protrusions 110 of the serrated shaft-engaging surface 100 engage the shaft 120 but impart substantially little or no pressure thereto. Thus, in FIG. 1B, the shaft is still at least somewhat movable within the aperture. In some embodiments, the arrangement of FIG. 1B may correspond to the largest diameter of the aperture, in which case FIG. 1A may be omitted. In FIG. 1C, the radially inward pressure 105 is increased so that the protrusions 110 intrude into the shaft-engaging surface 100, thereby forming marks 125 in the surface of the shaft 120.

### Insert

In some embodiments, the apparatus may be an insert apparatus for interposing between a shaft and a compression ring of a shrink disc assembly. The insert apparatus, which may be separate from the compression ring, includes an outer surface and a serrated inner surface configured for grippingly engaging the shaft. The insert apparatus may be ring-shaped, for example. In some embodiments, the outer surface of the insert apparatus may also be serrated and configured for grippingly engaging an inner surface of the compression ring. In other embodiments, the outer surface is unserrated, and may be smooth or roughened. Radial inward force is applied by the shrink disc to the insert, thereby gripping the insert within the shrink disc. The insert further transmits part of the applied radial inward force therethrough, so that the insert in turn grips the shaft.

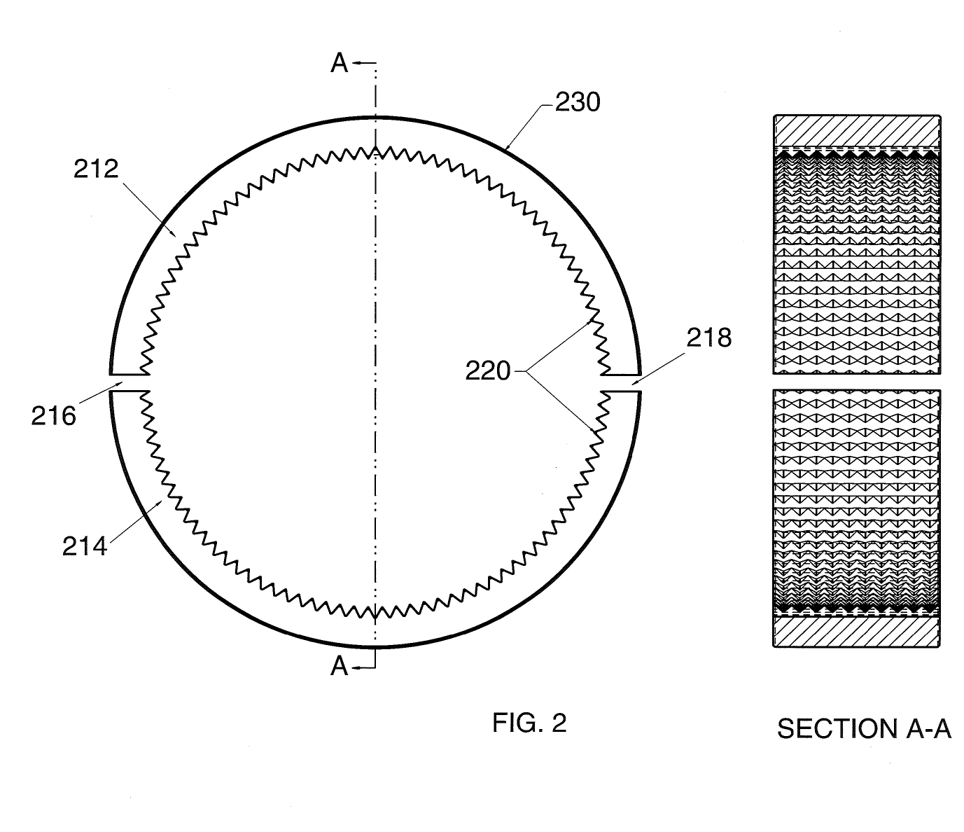

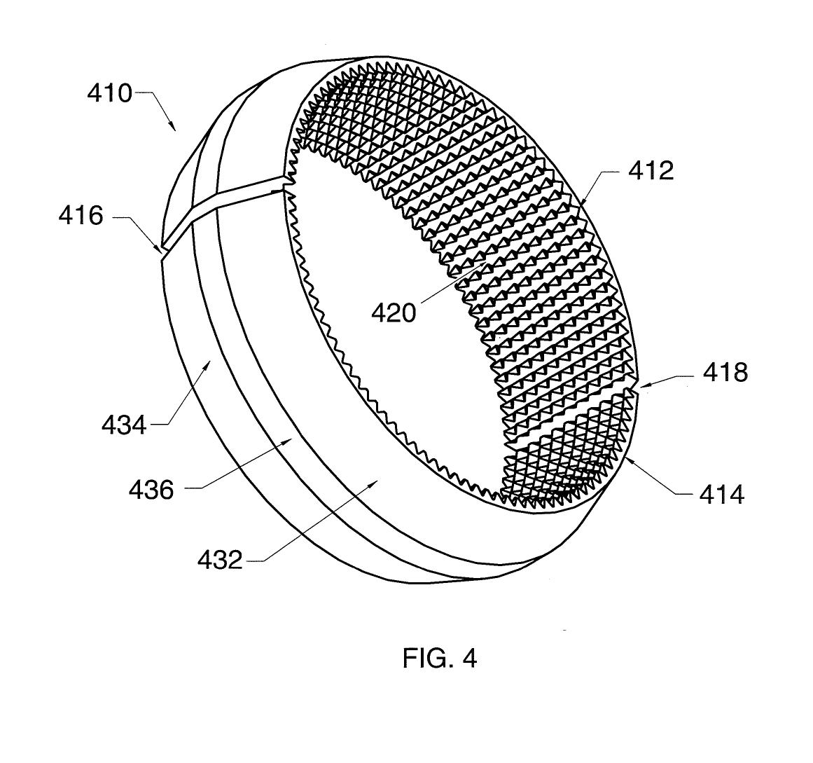

FIG. 2 illustrates an insert apparatus provided in accordance with an embodiment of the present invention. The insert apparatus comprises two arcuate, semicircular bodies 212, 214 separated by gaps 216, 218 extending in the axial direction. The bodies 212, 214 collectively provide a serrated inner surface 220 of the insert, which is configured for surrounding and grippingly engaging a cylindrical shaft when the bodies are arranged circumferentially around the shaft. The insert further includes an outer cylindrical surface 230 which is configured for engagement within and compression by a separate shrink disc apparatus. The outer cylindrical surface 230 is also collectively provided by the bodies 212, 214. The serrated inner surface 220 may be configured in a variety of ways, for example similarly to the serrated inner surface 420 as illustrated in FIG. 4, or as described elsewhere herein.

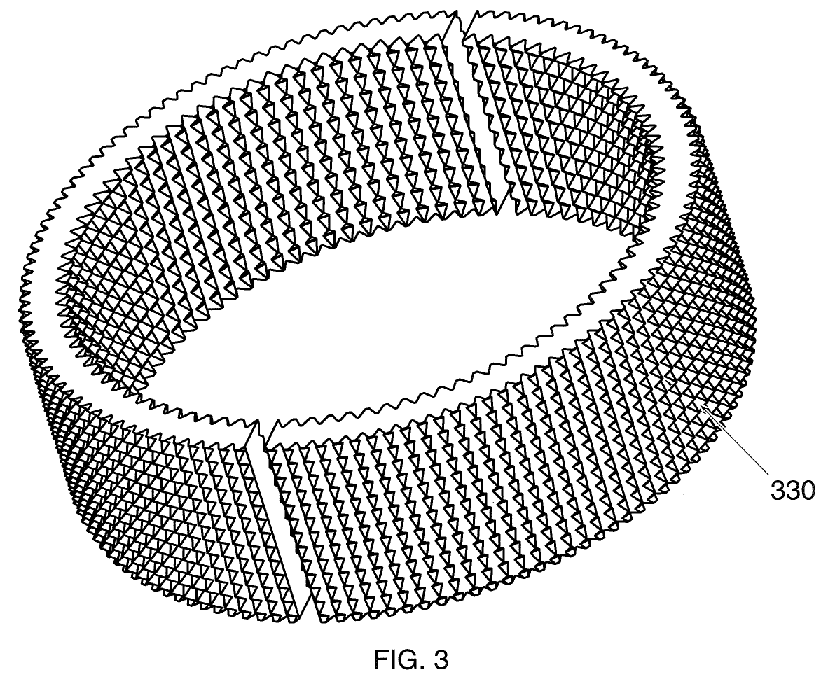

FIG. 3 illustrates an insert apparatus provided in accordance with another embodiment of the present invention. The insert apparatus is similar to that of FIG. 2, except that the outer cylindrical surface 330 is also serrated, in order to provide for gripping engagement with the shrink disc apparatus.

In some embodiments, the outer diameter of the insert is configured to provide an adequate amount of surface area such that a shrink disc assembly may adequately grip the insert substantially without slippage. As the outer diameter is increased by increasing radial thickness of the insert, a larger surface area of the outer surface is present for engagement with the shrink disc of appropriate size. In some embodiments, such an outer surface is unserrated. As such, the insert may be used as an adapter for facilitating mounting of a shrink disc onto a shaft which would otherwise have too small a diameter for adequate coupling with a conventional shrink disc, for a given application. The protrusions facilitate enhanced gripping of the shaft, while the serrated or unserrated outer surface of the insert provides a bearing surface for gripping by the shrink disc.

While a serrated outer surface of the insert may provide for enhanced gripping of the insert by the shrink disc, an unserrated outer surface may be desirable in some cases. For example, use of an unserrated surface allows for use of a shrink disc having an inner aperture diameter which more closely matches the insert outer diameter. As such, a shrink disc with a limited amount of diametric adjustability may be used. Further, the shrink disc itself remains substantially unmarked by an unserrated outer surface.

### Compression Ring

In other embodiments, the apparatus may be a compression ring portion of a shrink disc assembly. In such embodiments, the serrated inner surface is integral with the shrink disc rather than being provided as a separate insert component. For example, the compression ring portion may comprise an outer surface and a serrated inner surface configured for grippingly engaging the shaft as above. The outer surface may comprise an outer surface having at least one outer conical surface. The at least one outer conical surface may be used to cooperate with at least one mating inner conical surfaces of a pressure ring portion which is disposed radially outward of the compression ring portion. These inner conical surfaces cooperate with the outer conical surfaces of the compression ring portion to radially compress the compression ring portion when the pressure ring portion is axially moved against the compression ring portion, in accordance with a wedge effect.

FIG. 4 illustrates a compression ring portion 410 of a shrink disc, in accordance with embodiments of the present invention. The compression ring portion comprises two arcuate, semicircular bodies 412, 414 separated by gaps 416, 418 extending in the axial direction. The bodies 412, 414 collectively provide a serrated inner surface 420 of the compression ring portion, which is configured for surrounding and grippingly engaging a cylindrical shaft when the bodies are arranged circumferentially around the shaft. The compression ring portion further includes a pair of oppositely oriented outer conical surfaces 432, 434 and a ridge 436 extending in the circumferential direction and separating the pair of conical surfaces. The conical surfaces correspond to parts of oppositely facing cones which are centered on the axial center of the shaft. The conical surfaces 432, 434 and the ridge 436 are also collectively provided by the bodies 412, 414.

The serrated inner surface 420 comprises a plurality of teeth arranged in a rectangular grid. As illustrated, the interior teeth are shaped substantially as a regular square pyramid, while the teeth formed around the perimeters of the bodies 412, 414 are halves of rectangular pyramids. As also illustrated, the grid can comprise about 11 teeth in the axial direction and about 50 teeth per body 412, 414 in the circumferential direction. It will be appreciated that the serrated inner surface 420 may alternatively comprise a different arrangement of teeth.

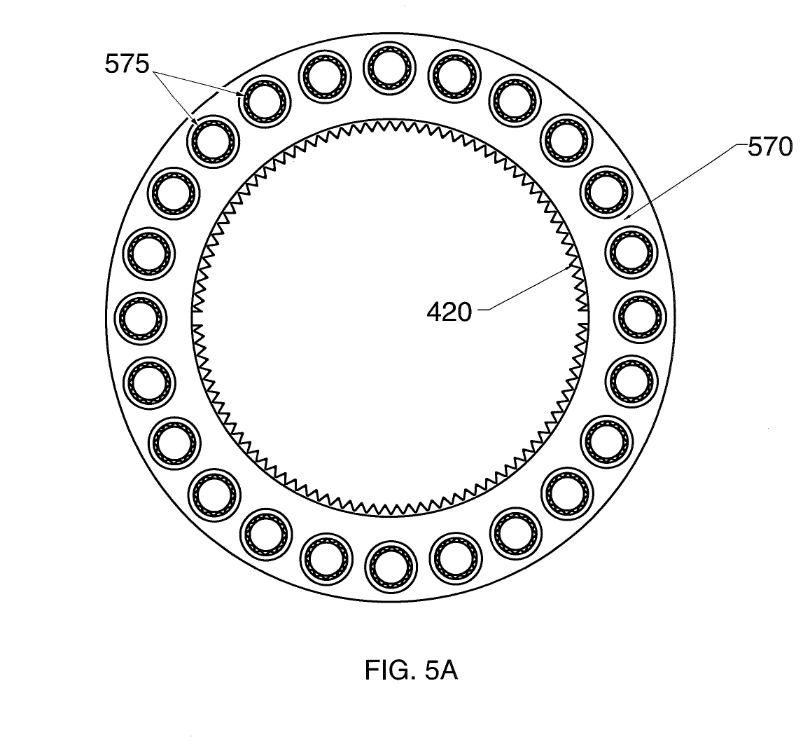

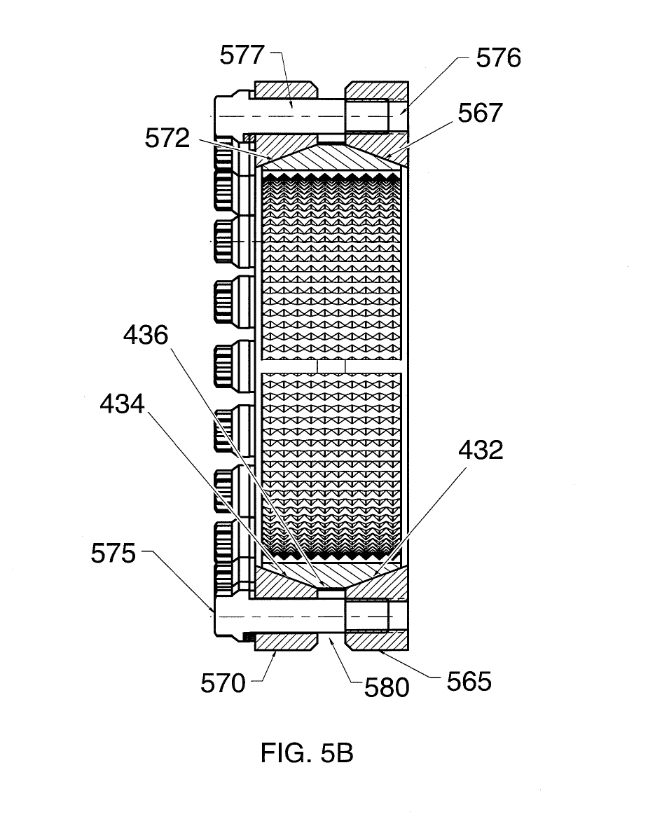

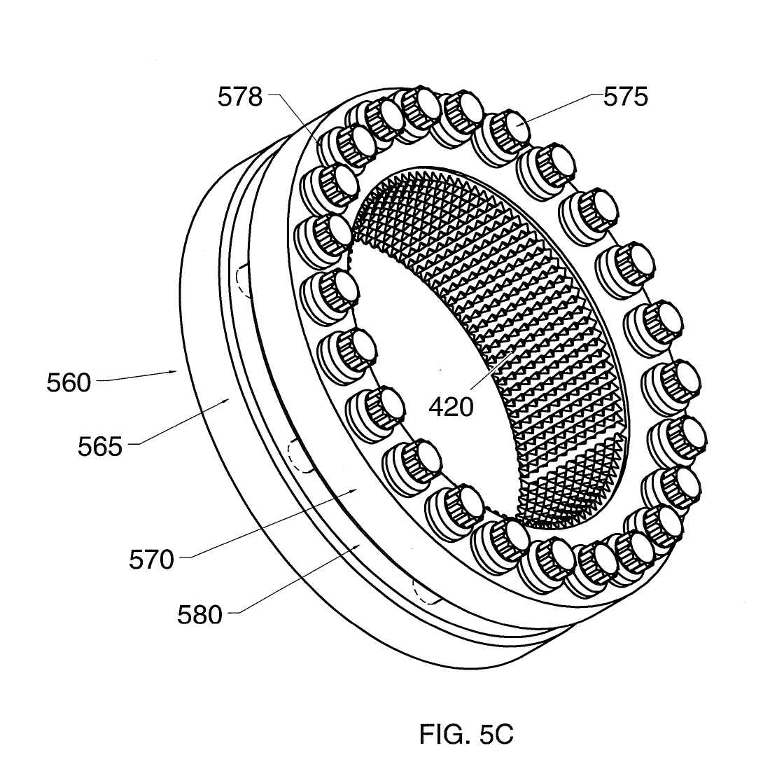

FIGS. 5A to 5C illustrate plan, cross-sectional and perspective views, respectively, of a shrink disc comprising the compression ring portion 410 of FIG. 4 as well as a pressure ring portion 560 disposed radially outward of the compression ring, in accordance with embodiments of the present invention. Example dimensions are also illustrated, which may be absolute or relative dimensions. The illustrated shrink disc is of the bi-conical style, and hence the pressure ring portion 560 comprises two halves 565, 570. Each half defines an inner surface 567, 572 (see FIG. 5B) which has an inward conical portion configured to contact a mating one of the pair of outer conical surfaces 432, 434. As the pressure ring halves 565, 570 are moved axially overtop of the compression ring portion, the pressure ring halves can be moved into or out of alignment with the pressure ring portion. The axial movement is induced by turning of the screws 575 to move the pressure ring halves 565, 570 toward or away from each other, thereby bringing the pressure ring into or out of alignment with the compression ring portion 410, respectively. The screws engage bores 576, 577 (see FIG. 5B) formed within the two halves of the pressure ring to impart the relative motion therebetween. The bores 576 of the pressure ring half 565 may be threaded while the bores 577 of the pressure ring half 570 may be drilled. The heads of the screws may impinge, for example directly or via washers 578 (see FIG. 5B), onto a surface of the pressure ring half 570 to assist in imparting the relative motion of the two halves. As the pressure ring moves into alignment with the compression ring portion in the axial direction, a wedge effect due to the mating conical surfaces imparts a radially inward pressure on the compression ring and toward the shaft. Thus, the screws allow for selectable application of the radially inward pressure. The pressure ring halves 565, 570 are separated by a gap 580 which generally aligns with the ridge 436 of the compression ring. This gap 580 facilitates the relative motion of the two pressure ring halves.

### Number of Gripping Bodies

In some embodiments, the apparatus, either the insert or the compression ring, may be formed of a single unitary body. In some embodiments, the unitary body may include a gap formed in the axial direction. Thus, for example, the insert apparatus may be “O” shaped or “C” shaped. The gap facilitates adjustment of the aperture size as the gap is narrowed or widened. Whether or not a gap is not present, the apparatus may transmit a radially inward pressure from its radially outer surface to its radial inner surface, potentially with limited or no change in the aperture diameter.

In other embodiments, the apparatus may be formed of a plurality of bodies which are cooperatively arranged to define an aperture therebetween. For example, the apparatus may comprise a pair of half-ring shaped bodies each defining part of the shaft-engaging surface, or three or more bodies each defining a corresponding fraction of the shaft-engaging surface. The bodies are sized such that, when arranged around the shaft, gaps are present between adjacent bodies. These gaps may cooperatively facilitate adjustment of the aperture size as the gaps are narrowed or widened.

In some embodiments of the present invention, use of a plurality of bodies rather than a single body may be advantageous for one or more reasons. First, the aperture diameter may be adjusted with reduced distortion in the aperture shape compared to a single “C”-shaped body. For example, this may be due to avoidance of exaggerated bending of the “C”-shaped body at a location opposite to the gap thereof. As such, the effective range of diameter adjustment of the aperture may be increased. This may in turn facilitate an adequate amount of diameter adjustment required in order to allow the protrusions to sufficiently intrude into the shaft surface. Second, the bodies may be arranged about the shaft directly, rather than sliding a single body onto the end of the shaft.

In some embodiments, the insert or compression ring is formed of a resilient material which returns to an initial shape as radially inward pressure thereupon is released. The material may be steel, such as spring steel, or another suitable metallic or non-metallic material. The material may have sufficient hardness that the protrusions thereof bite into or mark the shaft when sufficient radially inward pressure is applied.

### Shrink Disc Assembly

Yet other embodiments of the present invention provide a shrink disc assembly comprising a ring mechanism defining an internal aperture, which is configured to receive a shaft therein. The ring mechanism is operable to selectably apply a radially inward pressure to the shaft. Thus, in one configuration or mode, the ring mechanism may not apply the radially inward pressure, while in another configuration or more, the ring mechanism may apply the radially inward pressure. This allows the ring mechanism to be disposed on the shaft prior to tightening. The amount of radial inward pressure may be adjustable for example by turning of screws. As described elsewhere herein, the internal aperture includes an inner surface having one or more protrusions configured to grippingly engage the shaft upon application of the radially inward pressure.

In various embodiments, the radial pressure of the shrink disc is provided based on an application of the wedge effect. The shrink disc may therefore further include a radially inner compression ring portion having an outer surface and an inner surface. The outer surface includes at least one outward conical portion while the inner surface is the serrated surface. Such a shrink disc further includes a radially outer pressure ring portion having a second inner surface comprising at least one inward conical portion configured to cooperate with the at least one outward conical portion to apply the radially inward pressure by compression of the compression ring portion in response to alignment of the pressure ring portion with the compression ring portion in an axial direction.

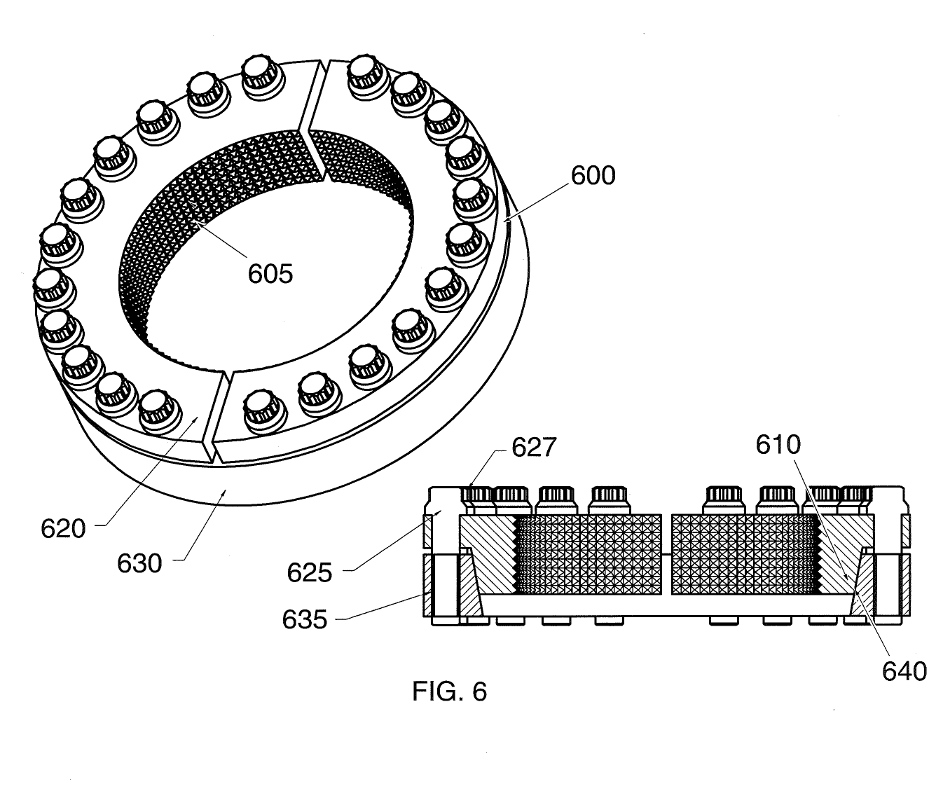

A bi-conical style shrink disc employing the wedge effect and a compression ring thereof has been described above with respect to FIGS. 4 to 5. Alternative styles of shrink disc may also be provided. For example, FIG. 6 illustrates a cross-sectional view of a single-conical style of shrink disc assembly provided in accordance with another embodiment of the present invention. As illustrated, the shrink disc includes a compression ring 600 having a serrated inner surface 605 and an outer surface comprising a single outward conical portion 610. The compression ring 600 further includes a flange 620 having apertures 625 for receiving a plurality of screws 627 therein, the apertures being arranged circumferentially around the shrink disc. The flange may be unthreaded. The shrink disc further includes a pressure ring 630 having a plurality of threaded apertures 635 for receiving the screws 627. The pressure ring 630 includes an inner surface comprising a single inward conical portion 640 configured to cooperate with the outward conical portion 610. As the pressure ring 630 is aligned with the compression ring 600 by turning action of the screws 627, radially inward pressure is applied to the compression ring 600, thereby causing gripping engagement of the shaft and/or intrusion of protrusions of the serrated inner surface 605 into the shaft. The compression ring 600 may be formed of a single “C”-shaped body rather than plural separate bodies. This arrangement may simplify operation by reducing the potential for different parts of the compression ring to come out of alignment during tightening. However, it is contemplated that the compression ring 600 may alternatively comprise a plurality of arcuate portions arranged circumferentially around a shaft and separated by gaps.

In some embodiments, a mechanism other than screws or bolts may be used to align the pressure ring with the compression ring. For example, an axial force applied by an external tool such as a hydraulic driver may be used to induce such alignment. Frictional forces or other means may then be used to retain the axial alignment until an opposite axial force is applied by the same or a different external tool.

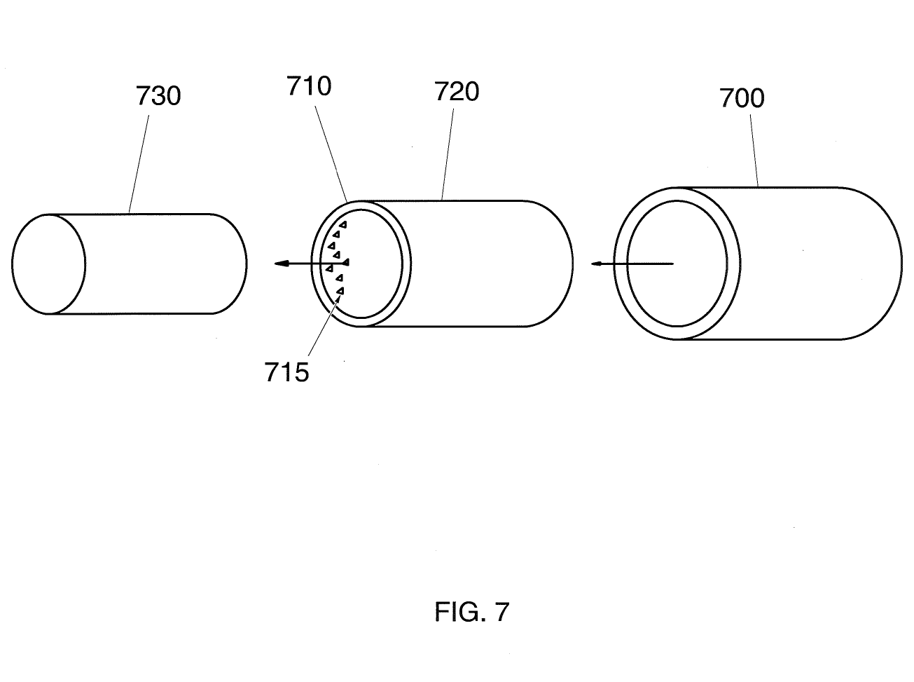

As another example, FIG. 7 illustrates a thermal expansion style compression ring 700 for disposal on a shaft 730. The compression ring 700 is formed of a material, such as metal, which expands upon heating and contracts upon cooling. As such, the compression ring 700 may be heated prior to disposal on the shaft, and radially inward pressure may be applied as the compression ring cools. Although in some embodiments a surface of the compression ring's interior aperture may be serrated, the present embodiment illustrates an insert apparatus 710 which is interposed between the compression ring 700 and the shaft, by locating the shaft within a serrated aperture 715 of the insert apparatus and locating the insert apparatus within an aperture of the compression ring 700. An external cylindrical surface 720 of the insert apparatus may be serrated or unserrated. This configuration may be desirable in various instances, since the protrusions of the serrated surface are not directly heated (although they may be indirectly heated to a certain degree by the compression ring), and therefore may be more resilient to deformation.

### Protrusion Configurations

Embodiments of the present invention may incorporate various sizes, shapes, orientations, arrangements, varieties and/or densities of protrusions corresponding to the serrated surface or surfaces of a compression ring or insert. The protrusion configuration may depend on one or more factors, such as desired performance characteristics, manufacturability, part tolerances, diametric adjustability of the shrink disc, and the like. Although several particular examples are set forth below, it should be understood that other protrusion configurations may also be possible.

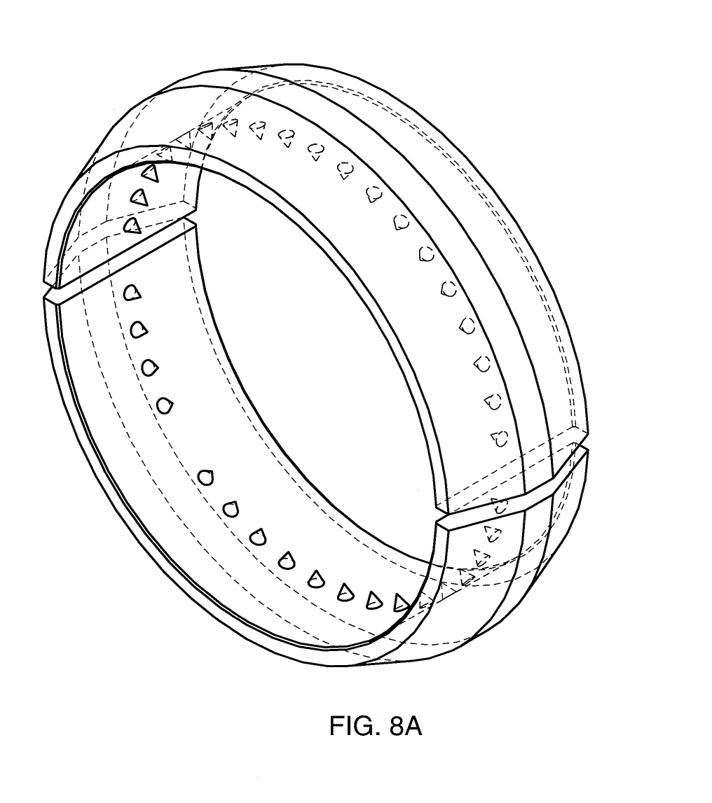

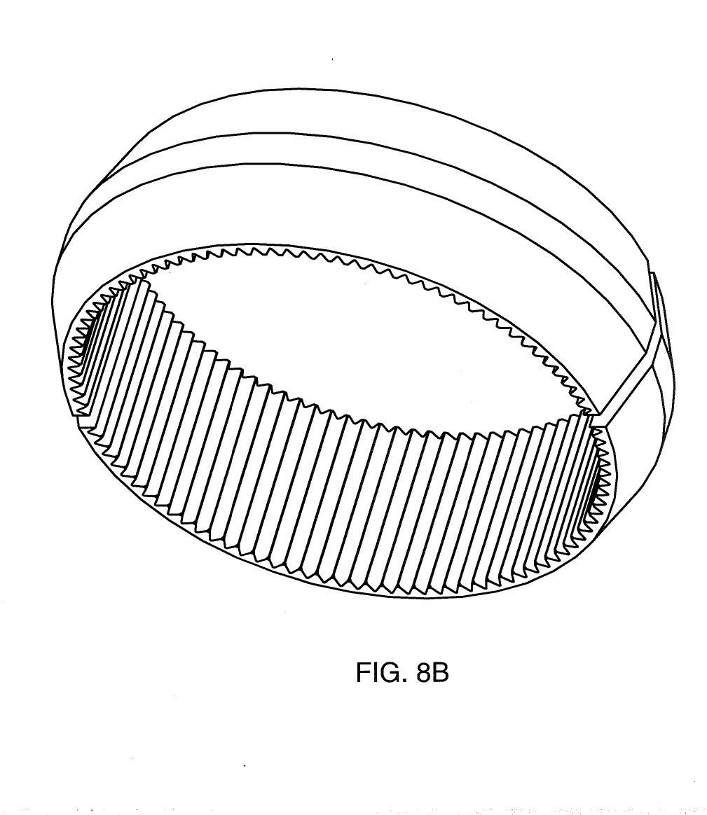

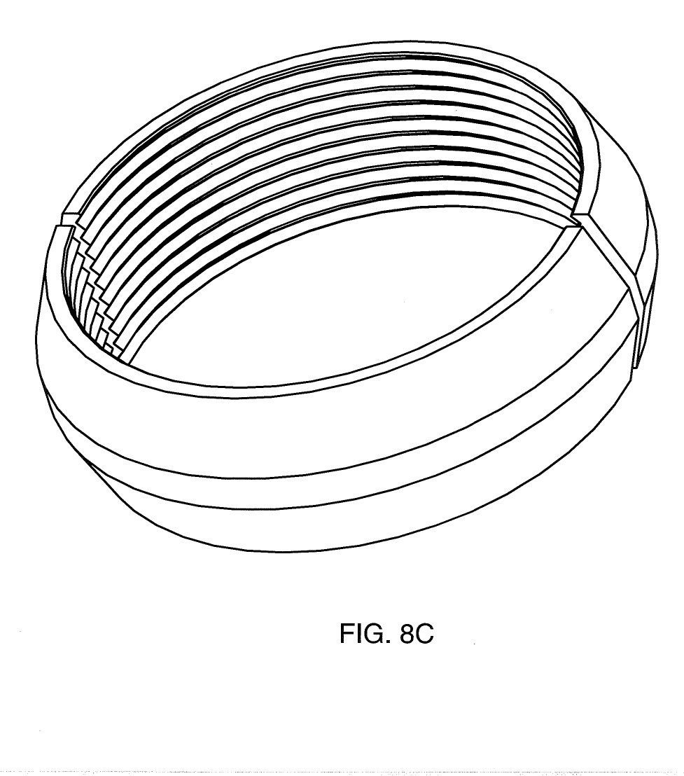

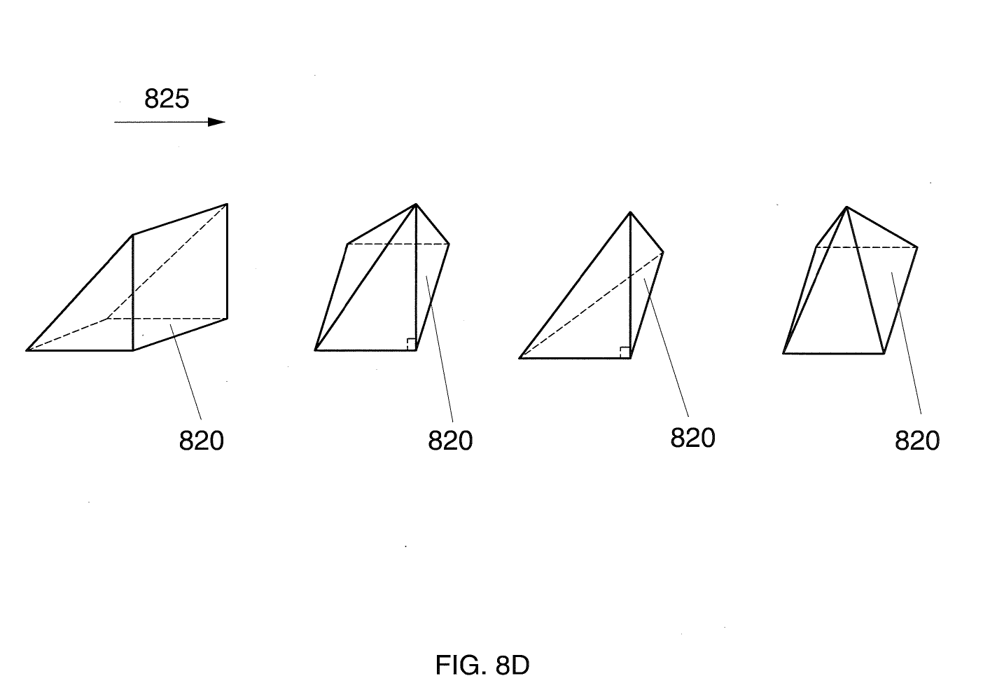

In various embodiments, the protrusions may be arranged sparsely or densely upon the serrated surface, in a regular or irregular pattern. In one embodiment, a small number of protrusions are located in a spaced-apart configuration, for example as illustrated in FIG. 8A. This may provide for adequate functionality in some applications while limiting shaft marking. In another embodiment, the protrusions are arranged in a grid pattern, such as a rectangular or hexagonal grid pattern, which covers some or substantially all of the serrated surface. The protrusions may in particular be substantially sharp, spiked protrusions terminating at a point.

In yet another embodiment, the protrusions are elongated to form substantially sharp ridges extending in the axial direction, such as illustrated in FIG. 8B, a circumferential direction, such as illustrated in FIG. 8C, or in a clockwise or counter-clockwise spiral direction, or the like, and may be arranged side by side with or without spacing. Axially extending ridges may be used for example when it is desired to primarily inhibit slippage in the circumferential direction, while circumferentially extending ridges may be used for example when it is desired to primarily inhibit axial slippage. Axially extending protrusion ridges may also function substantially similarly to a key block which is self-tapping. Spiral protrusion ridges may inhibit slippage in plural directions while potentially being susceptible to slippage under a twisting motion commensurate with the spiral.

In some embodiments, the protrusion size may be configured based on considerations such as durability, available amount of diametric adjustment of the associated shrink disc, desired angle of the protrusion faces, desired amount of intrusion into the shaft, or the like, or a combination thereof. In one embodiment, the protrusions have a base length equal to about 1% of the circumference of the serrated surface base, and a height about equal to the base length.

In some embodiments, the angle of the protrusion faces may be configured based on considerations such as manufacturability, a desired amount of force required for intrusion into and/or marking of the shaft, or the like.

In some embodiments, a protrusion may extend radially, that is perpendicularly from a base portion of the serrated surface, and may further be substantially symmetric about its axis of extension. Regular conical or pyramid-shaped protrusions are examples of this configuration.

In some embodiments, a protrusion may be asymmetric. For example, at least one face of the protrusion may extend from the base of the serrated surface at a steeper angle than at least one other face. In some embodiment, an asymmetric protrusion may be substantially sawtooth shaped, for example having a first portion extending directly radially inward, that is, perpendicularly from the base portion of the serrated surface, and having a second portion extending at an angle to form a peak with the first portion. The first portion may correspond to a single face or two adjacent faces of a protrusion. The sawtooth protrusion may have a square or triangular base, for example. In one embodiment, a double-sawtooth configuration, in which pairs of adjacent protrusions exhibit an “M” shaped cross section, may be provided. Various examples of asymmetric protrusion shapes are illustrated in FIG. 8D.

In some embodiments, asymmetric protrusions, such as sawtooth protrusions, may be used to preferentially brace against slippage in a given direction. For example, when it is desired to preferentially brace against slippage due to a force (or component of a force) that is applied in a particular direction, such as an axial direction, clockwise or counter-clockwise circumferential direction, or a combination thereof, protrusions may be provided which include a steeper face on the side of the protrusion that is further from the force origin than on the side of the protrusion that is closer to the force origin, as also illustrated in FIG. 8D where the steeper face 820 is shown relative to the applied force 825. In other words, the steeper face 820 faces away from an expected source of slippage-inducing force 825. Such forces may include forces expected to be induced when tightening screws, forces resulting from shaft rotation or axial loading, or the like.

In some embodiments, a variety of different protrusion types may be provided on the same serrated surface. This may allow for a mixing of advantages of the different protrusion types.

### Methods of Coupling Shrink Disc to Shaft

Embodiments of the present invention provide for methods of coupling a shrink disc to a shaft, wherein either the shrink disc or an insert includes a serrated surface for grippingly engaging the shaft.

In some embodiments, there is provided a method of coupling a shrink disc assembly to a shaft. The method includes locating the shaft within an internal aperture defined by the shrink disc assembly. The internal aperture includes an inner surface having one or more protrusions as described elsewhere herein. The method further includes operating the ring mechanism to apply a radially inward pressure to the shaft via the inner surface. The radially inward pressure causes the one or more protrusions to grippingly engage the shaft.

In other embodiments, there is provided a method of coupling a shrink disc assembly to a shaft. The method includes providing an insert apparatus defining an internal aperture. The internal aperture includes an inner surface having one or more protrusions. The method further includes locating the shaft within the internal aperture of the insert apparatus. The method further includes locating the insert apparatus within a further internal aperture defined by the shrink disc assembly. The method further includes operating the ring mechanism to apply a radially inward pressure to the insert apparatus and to the shaft via the insert apparatus. The radially inward pressure causes the one or more protrusions of the insert apparatus to grippingly engage the shaft.

In some embodiments, and in association with the methods described herein, the shrink disc assembly includes a radially inner compression ring portion and a radially outer pressure ring portion. The compression ring portion includes an outer surface comprising at least one outward conical portion as well as the inner surface of the internal aperture. The pressure ring portion includes a second inner surface comprising at least one inward conical portion configured to cooperate with the at least one outward conical portion. The method in such embodiments further includes aligning the pressure ring portion with the compression ring portion in an axial direction, thereby applying the radially inward pressure to the shaft via compression of the compression ring portion.

### Applications

Embodiments of the present invention may be used in coupling together a pair of shafts, such as cylindrical rotating shafts, for example in association with a tool joint. One of the shafts may be driven by a motor while another is connected to a load or tool, for example. Further, a first shaft may comprise a tapered or non-tapered cavity, while a second shaft may comprise an extension which fits within the cavity to provide a mating connection between the shafts. The first shaft may include a slot which facilitates inward movement of the part of the first shaft surrounding the cavity, in order to grip the second shaft when inserted therein.

In some embodiments, a shrink disc may be coupled to an exterior of the cavity-containing first shaft so that an inner surface imparts a radially inward force to the first shaft in order to impart radially inward force for gripping of the second shaft within the first shaft cavity. The first shaft may include at least one slot in its surface, the slot communicating with the cavity, so that the first shaft can deform to grip the second when subjected to radially inward compressive force.

In some embodiments, the shrink disc may be located so that straddles both of the first shaft and the second shaft. That is, the shrink disc may grippingly engage both an exterior surface of the first shaft as well as an exterior surface of the second shaft. As such, the shrink disc itself may provide at least part of the coupling between the two shafts. A first circumferential portion of the shrink disc inner surface may surround and engage an exterior portion of the first shaft, while a second circumferential portion of the shrink disc inner surface, adjacent to the first circumferential portion, may surround and engage an exterior portion of the second shaft when mated with the first shaft.

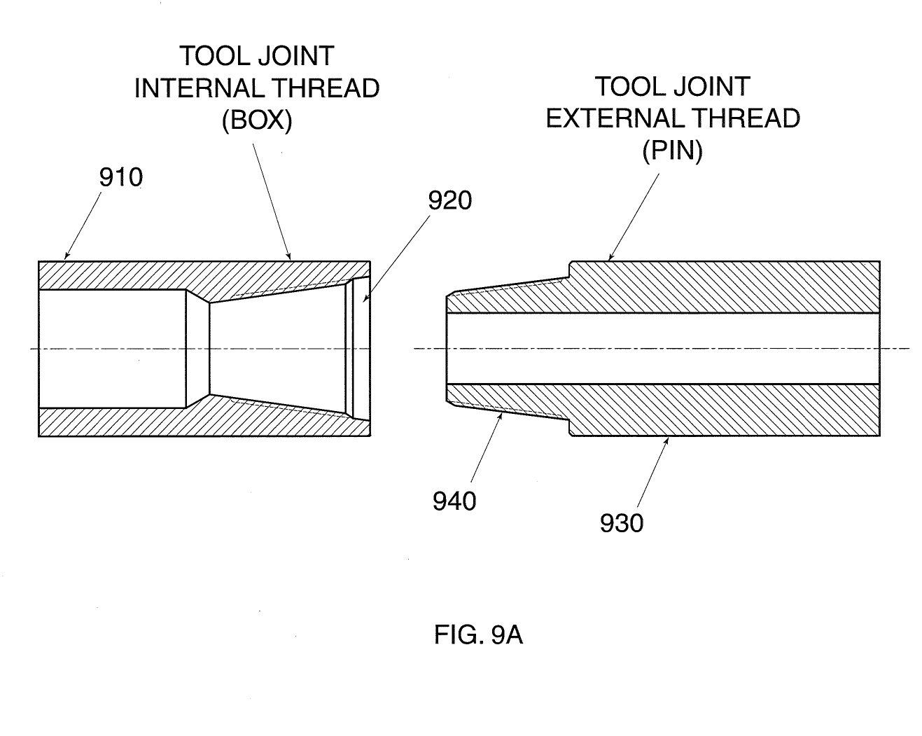

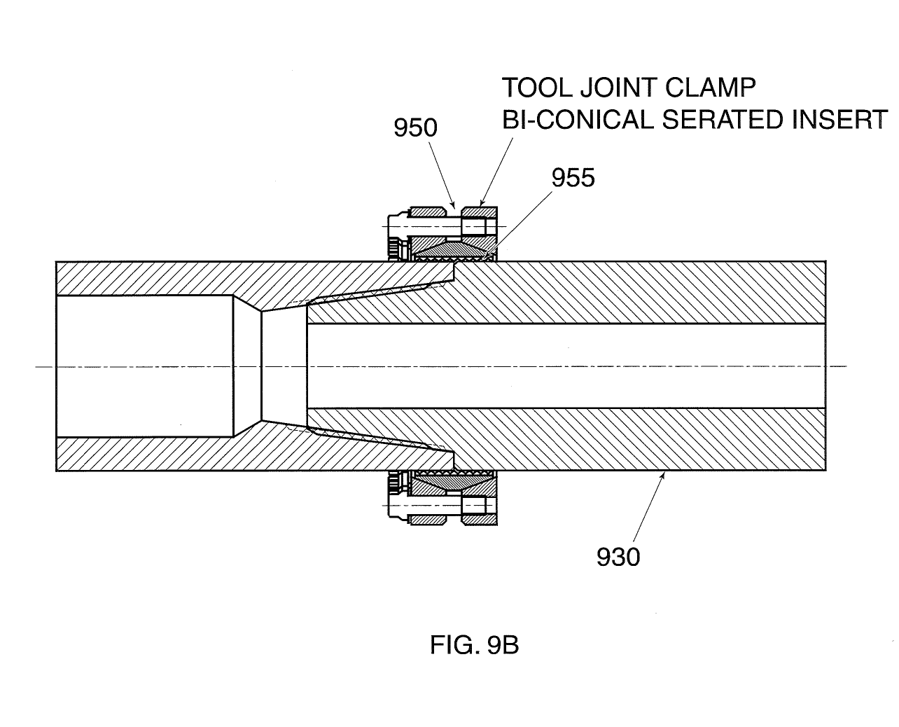

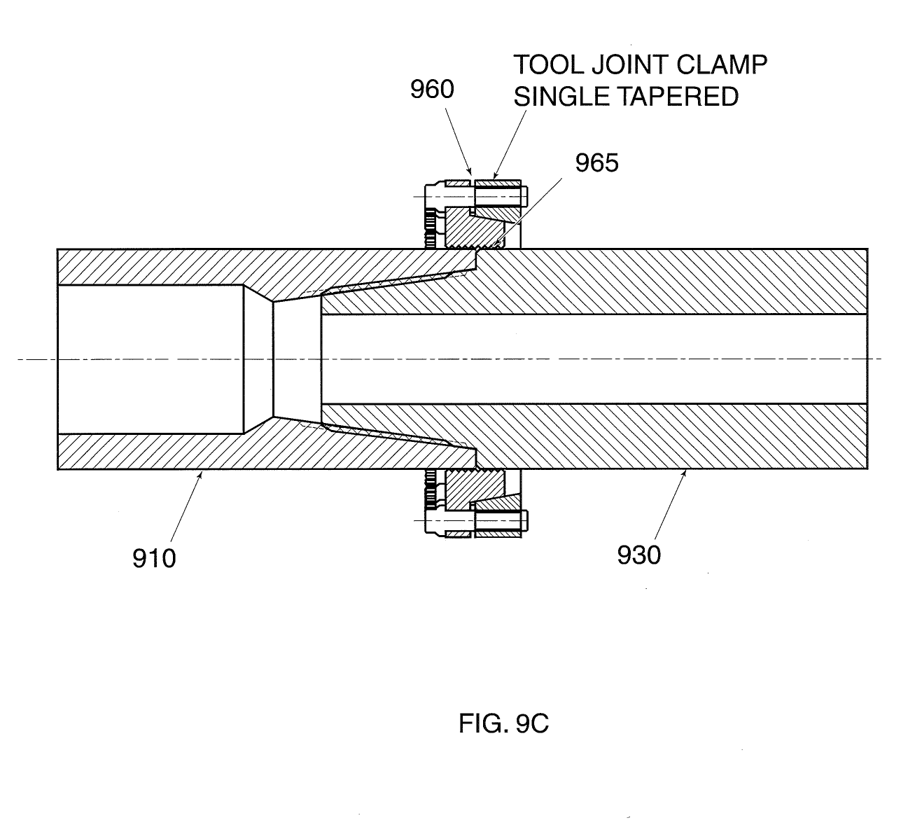

FIGS. 9A to 9C illustrate cross-sectional views of a pair of shafts for coupling together using a shrink disc assembly, in accordance with embodiments of the present invention. FIG. 9A illustrates a first shaft 910 having a tapered, frustro-conical aperture 920. The sidewall of the aperture may be threaded. FIG. 9A further illustrates a second shaft 930 having a tapered, frustro-conical extension 940. The face of the extension may also be threaded for mating with the aperture 920. The aperture 920 and the extension 940 may be sized and shaped such that the extension fits or screws snugly into the aperture.

FIGS. 9B and 9C illustrate the first shaft 910 coupled to the second shaft 930, including insertion of the extension 940 of the second shaft into the aperture 920 of the first shaft. In FIG. 9B, a bi-conical shrink disc 950 is positioned straddling the first shaft and the second shaft, such that a first portion of a serrated inner surface 955 of the shrink disc contacts an outer surface of the first shaft, and a second portion of the serrated inner surface 955 contacts an outer surface of the second shaft. Similarly, in FIG. 9C, a single tapered shrink disc 960 is positioned straddling the first shaft and the second shaft, such that a first portion of a serrated inner surface 965 of the shrink disc contacts an outer surface of the first shaft, and a second portion of the serrated inner surface 965 contacts an outer surface of the second shaft. In both cases, the shrink disc may then be tightened to provide gripping engagement of both the first shaft and the second shaft.

Embodiments of the present invention may facilitate gripping engagement of both of a pair of mated shafts when straddling same, even when the outer diameters of the pair of shafts are mismatched by up to a nominal amount. For example, as illustrated in FIGS. 9B and 9C, a shrink disc may be located such that a serrated inner surface of the shrink disc (or associated insert) straddles both of the pair of mated shafts as described above. Notably, the outer diameter of one of the mated shafts may differ by up to a nominal amount from the outer diameter of the other of the mated shafts. This difference in outer diameters may be due to manufacturing variation, for example. In some embodiments, the nominal amount by which two shaft diameters differ may be up to about one or two times the length of the protrusions of the serrated inner surface.

In some embodiments, whereas a prior art shrink disc with a flat inner surface may fail to grippingly engage both shafts when the shaft outer diameters are mismatched, the serrated inner surface provided in accordance with the present invention may in fact facilitate or enhance engagement of both shaft outer diameters. For example, the serrations may intrude further into the larger-diameter shaft while still contacting the smaller-diameter shaft and potentially intruding into the smaller-diameter shaft to a lesser degree. As another example, the serrations may deform under compressive contact with the larger-diameter shaft, thereby facilitating further travel of the shrink disc to engage the serrated inner surface with the smaller-diameter shaft. In effect, the serrated inner surface presents a range of aperture diameters for accommodating and grippingly engaging a range of shaft diameters therein. For example, two shafts having different diameters can be accommodated and grippingly engaged concurrently when the serrated inner surface is disposed to contact both shafts.

In various embodiments, the gripping engagement provided by the serrated surface or surfaces is configured to inhibit slippage during installation of the shrink disc on the shaft. For example, during tightening of the shrink disc to the shaft by application of radial inward pressure, but before full tightening of the shrink disc to the shaft, mechanical forces corresponding to the tightening may tend to cause slippage of the partially-engaged shrink disc. Such mechanical forces may result from turning of tightening screws or bolts, for example. To counter this, the protrusions of the serrated surface may be configured to grippingly engage the shaft to a greater degree earlier in the tightening process, relative to a comparable non-serrated shrink disc. In some embodiments, the protrusions may be sized, shaped and/or oriented particularly so as to brace against slippage, such as rotational or axial slippage, in directions that are anticipated to occur during tightening.

Various embodiments of the present invention may be applied in the following situation. For a shrink disc operating based on the wedge effect, a compression ring portion and a pressure ring portion thereof may interface along mating conical surfaces. When the angle between the conical surfaces and the axial direction is less than 45 degrees, a mechanical advantage may be present in which an axial force, which is applied to move the compression ring portion axially relative to the pressure ring portion, is amplified as it is transformed into a radially compressive force. When a screw mechanism, such as a set of screws, is used to effect the axial movement, a further mechanical advantage may be applied due to the helical pitch of the screw mechanism. However, in practice, the axial force may not be perfectly transformed into the radially compressive force. For example, static friction or “stiction” between the mating conical surfaces may tend to induce an axial translation moment of the compression ring with respect to the shaft. As another example, when a pair of oppositely facing conical surfaces are present, static friction present simultaneously on both conical surfaces may tend to induce a radial buckling moment in the compression ring, which may potentially result in uneven distribution of the compressive force. Such an axial translation moment and/or radial buckling moment may be countered by use of a serrated surface engaging the shaft, as described elsewhere herein. This in turn may allow for a greater freedom in choosing the design parameters of the shrink disc. For example, a greater freedom in choosing the angle of the conical surfaces may be provided as constraints due to the above-described static friction problems are relaxed.

As another example, when tightening screws located around the perimeter of a shrink disc in order to apply compressive force, the turning of a screw may result in a force applied to the shrink disc in the circumferential direction. This may tend to cause slippage of the shrink disc in the circumferential direction. The protrusions may be configured to brace against such slippage by appropriate angling of the protrusions. For example, if the potential slippage of the shrink disc due to a force oriented in the clockwise direction, the protrusions may include sawtooth shaped teeth each having a steeper face on the clockwise side of the protrusion, that, the side which is further from the force origin than on the side of the protrusion that is closer to the force origin.

In some embodiments, the gripping engagement provided by the serrated surface or surfaces is configured to inhibit slippage after installation of the shrink disc on the shaft. For example, a tool may be coupled to the shrink disc assembly which functions to impart rotation of the shaft for operation of the tool. As another example, the shrink disc may be part of an assembly which is configured to couple a driven rotating shaft to a second rotating shaft, so that torque is transmitted through the assembly to the second rotating shaft. The serrated surface may function to provide grip which braces at least against counter forces induced by the shaft rotation, when the shaft rotates in at least one direction. As yet another example, the shrink disc may carry an axial load, and the protrusions may be configured to brace against potential slippage due to such an axial load. Such protrusions may for example include appropriately oriented sawtooth shaped teeth which are pointed or ridged.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

What is claimed is:

1. An apparatus for interposing between a shaft and a portion of a shrink disc assembly, the shrink disc assembly configured to receive the shaft within an aperture thereof and to selectably apply a radially inward pressure to the shaft, the apparatus comprising a serrated inner surface configured to grippingly engage the shaft.

2. The apparatus of claim 1, wherein the apparatus comprises a plurality of arcuate portions arranged circumferentially around the shaft to collectively provide the serrated inner surface, the plurality of arcuate portions separable from one another by a plurality of axially extending gaps at least when the radially inward pressure is relaxed.

3. The apparatus of claim 1, wherein the apparatus is a single unitary body configured to surround the shaft to provide the serrated inner surface, the single unitary body forming a ring or forming a ring having an extending gap therein.

4. The apparatus of claim 1, wherein the serrated inner surface comprises one or more protrusions, and wherein grippingly engaging the shaft comprises intrusion of the one or more protrusions into the shaft.

5. The apparatus of claim 1, wherein the apparatus is integral with an inner compression ring portion of the shrink disc assembly.

6. The apparatus of claim 5, wherein the inner compression ring portion comprises a plurality of arcuate portions arranged circumferentially around the shaft to collectively provide the serrated inner surface, the plurality of arcuate portions separable from one another by a plurality of axially extending gaps at least when the radially inward pressure is relaxed.

7. The apparatus of claim 5, wherein the inner compression ring portion includes an outer surface having at least one outward conical portion.

8. The apparatus of claim 6, wherein the shrink disc assembly further comprises an outer pressure ring portion defining an inner surface having at least one inward conical portion configured to contact the at least one outward conical portion of the inner compression ring, the outer pressure ring portion and the inner compression ring portion cooperatively configured to apply radially inward compression toward the shaft in response to alignment of the at least one inward conical portion with the at least one outward conical portion.

9. The apparatus of claim 1, wherein the apparatus is an insert apparatus for interposing between the shaft and an inner compression ring portion of the shrink disc assembly.

10. The apparatus of claim 9, wherein the insert apparatus comprises a serrated outer surface configured to grippingly engage the aperture of the shrink disc upon application of the radially inward pressure.

11. The apparatus of claim 1, wherein the serrated inner surface comprises one or more spiked protrusions terminating at a point, one or more radially extending ridged protrusions, one or more axially extending ridged protrusions, or a combination thereof.

12. The apparatus of claim 1, wherein the serrated inner surface comprises one or more symmetric protrusions, one or more asymmetric protrusions, or a combination of symmetric protrusions and asymmetric protrusions.

13. The apparatus of claim 1, wherein the serrated inner surface comprises one or more asymmetric protrusions having a first side and a second side, the first side extending radially at a steeper angle than the second side, the first side disposed on a side of the protrusion that faces away from an expected source of slippage-inducing force.

14. The apparatus of claim 13, wherein the one or more asymmetric protrusions further include a third side adjacent to the first side, the third side extending radially at a steeper angle than a side opposite the third side, the third side disposed on another side of the protrusion that faces away from a second expected source of slippage-inducing force.

15. The apparatus of claim 1, wherein the serrated inner surface comprises two or more protrusions, at least two of the two or more protrusions being differently shaped.

16. A shrink disc assembly comprising:
a ring mechanism defining an internal aperture configured to receive a shaft therein, the ring mechanism operable to selectably apply a radially inward pressure to the shaft, the internal aperture comprising an inner surface having one or more protrusions configured to grippingly engage the shaft upon application of said radially inward pressure.

17. The shrink disc assembly according to claim 16, further comprising:
a) a radially inner compression ring portion having: an outer surface comprising at least one outward conical portion; and the inner surface of the internal aperture; and
b) a radially outer pressure ring portion having a second inner surface comprising at least one inward conical portion configured to cooperate with the at least one outward conical portion to apply the radially inward pressure by compression of the compression ring portion in response to alignment of the pressure ring portion with the compression ring portion in an axial direction.

18. The shrink disc assembly according to claim 17, wherein the compression ring portion comprises a plurality of arcuate portions arranged circumferentially around the shaft to collectively provide the serrated inner surface, the plurality of arcuate portions separable from one another by a plurality of axially extending gaps at least when the radially inward pressure is relaxed.

19. The shrink disc assembly according to claim 16, wherein grippingly engaging the shaft comprises intrusion of the one or more protrusions into the shaft.

20. The shrink disc assembly according to claim 16, wherein the one or more protrusions include one or more spiked protrusions terminating at a point, one or more radially extending ridged protrusions, one or more axially extending ridged protrusions, one or more symmetric protrusions, one or more asymmetric protrusions, or a combination thereof.
